(19) United States
(12) Patent Application Publication
(10) Pub. No.: US 2008/0112384 A1
(43) Pub. Date: May 15, 2008

(54) Apparatus for merging beacon of wireless local network and method using the same

(75) Inventors: Chang Woo Seo, Yongin-si (KR); Jun Seo Lee, Yongin-si (KR); Jun Haeng Cho, Yongin-si (KR); Yong Suk Kim, Yongin-si (KR); Seung Hwan Oh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/723,285

(22) Filed: Mar. 19, 2007

(30) Foreign Application Priority Data
Nov. 13, 2006 (KR) 10-2006-0111720

(51) Int. Cl. H04J 1/00

(52) U.S. Cl. 370/343

(57) ABSTRACT

An apparatus and method of merging beacons in a wireless local network are provided. The method of merging beacons in a wireless local network includes: calculating a continuous occurrence frequency of a received alien beacon period (BP); comparing the calculated occurrence frequency with a certain reference occurrence frequency; and merging a beacon group of a corresponding device with an alien beacon group when the calculated occurrence frequency is greater than or equal to the reference occurrence frequency.

### CROSS-REFERENCE TO RELATED APPLICATION

This application claims priority from Korean Patent Application No. 10-2006-0111720, filed on Nov. 13, 2006, in the Korean Intellectual Property Office, the entire disclosure of which is incorporated herein by reference.

### BACKGROUND OF THE INVENTION

1. Field of the Invention

Methods and apparatuses consistent with the present invention relate to a merging beacons in a wireless local network, and more particularly, to an apparatus and method of merging beacons in a wireless local network which can prevent an unnecessary merging of beacons between beacon groups in a WiMedia Media Access Control (MAC)

2. Description of Related Art

In a WiMedia Media Access Control (MAC), individual devices constitute a beacon group without a central coordinator.

Also, in the WiMedia MAC, all devices must search for, generate, and maintain a superframe synchronization. Specifically, devices, which are included in an identical beacon group, have the same superframe start time.

When a device receives a beacon from another device, which is included in another beacon group, an operation of merging these two beacon groups is performed.

In a conventional art; when a corresponding device receives a beacon from another beacon group, the corresponding device merges a beacon group of the corresponding device with the different beacon group into a single beacon group. Specifically, every time an additional beacon is received from the different beacon group, a merging is performed.

As described above, in the conventional art, the merging is performed every time a beacon of the different beacon group is received. Therefore, when the beacon of the different group is temporarily received, an unnecessary merging of beacons is performed.

For example, even when an alien beacon of a moving alien beacon group is temporarily received, a merging of beacons between a beacon group, which receives the alien beacon, and the alien beacon group is performed, i.e. an unnecessary merging of beacons is performed.

Also, in a conference room where a plurality of beacon groups may be provided, a received alien beacon frequently changes and thus, a merging of beacons is also frequently performed. Therefore, resources and power may be unnecessarily consumed.

Therefore, a device capable of preventing an unnecessary merging of beacons, which may be caused by a temporarily received alien beacon, is required.

### SUMMARY OF THE INVENTION

An aspect of the present invention is to prevent an unnecessary merging of beacons, which may be caused by a temporarily received alien beacon.

An aspect of the present invention is to remove an unnecessary merging of beacons and thereby reduce an unnecessary resource consumption and power consumption.

According to an aspect of the present invention, there is provided a method of merging beacons in a wireless local network, the method including: calculating a continuous occurrence frequency of a received alien beacon period (BP); comparing the calculated occurrence frequency with a certain reference occurrence frequency; and merging a beacon group of a corresponding device with an alien beacon group when, the calculated occurrence frequency is greater than or equal to the reference occurrence frequency.

Also, the method may further include: protecting the received alien BP; and releasing the protection of the received alien BP when the calculated occurrence frequency is less than the reference occurrence frequency.

Also, the calculating may determine whether the received alien BP is identical to a previously received alien BP, and may calculate the continuous occurrence frequency of the identical alien BP when the received alien BP is identical to the previously received alien BP.

Also, the reference occurrence frequency may be applied by a different superframe time according to a detection range of a device or an operational purpose of the device.

According to another aspect of the present invention, there is provided an apparatus for merging beacons in a wireless local network, the apparatus including: an occurrence frequency calculator which calculates a continuous occurrence frequency of a received alien BP, an occurrence frequency comparator which compares the calculated occurrence frequency with a certain reference occurrence frequency; and a beacon merging management unit which merges a beacon group of a corresponding device with an alien beacon group when the calculated occurrence frequency is greater than or equal to the reference occurrence frequency.

Also, the apparatus may further include an alien BP management unit which protects the received alien BP, and releases the protection of the received alien BP when the calculated occurrence frequency is less than the reference occurrence frequency.

Also, the occurrence frequency calculator may determine whether the received alien BP is identical to a previously received alien BP, and calculate the continuous occurrence frequency of the identical alien BP when the received alien BP is identical to the previously received alien BP.

Also, the beacon merging management unit may include: a beacon group determination unit which determines whether the beacon group of the corresponding device is identical to a reference beacon group; a BP switch information generation unit which generates BP switch information when the beacon group of the corresponding device is different from the reference beacon group; and a beacon merging unit which merges the beacon group of the corresponding device with the alien beacon group based on the BP switch information.

### BRIEF DESCRIPTION OF THE DRAWINGS

The above and other aspects and advantages of the present invention will become apparent and more readily appreciated from the following detailed description of certain exemplary embodiments of the invention, taken in conjunction with the accompanying drawings of which:

FIG. 1 is a block diagram illustrating an apparatus for merging beacons in a wireless local network according to an exemplary embodiment of the present invention;

FIG. 2 is a block diagram illustrating a beacon merging management unit shown in FIG. 1;

FIG. 3 is a diagram illustrating an example of two beacon groups to explain an apparatus for merging beacons in a wireless local network according to an exemplary embodiment of the present invention;

FIG. 4 is a diagram illustrating an example before and after merging two beacon groups according to an exemplary embodiment of the present invention;

FIG. 5 is a flowchart illustrating a method of merging beacons in a wireless local network according to an exemplary embodiment of the present invention; and

FIG. 6 is a flowchart illustrating an operation of merging beacons shown in FIG. 5.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

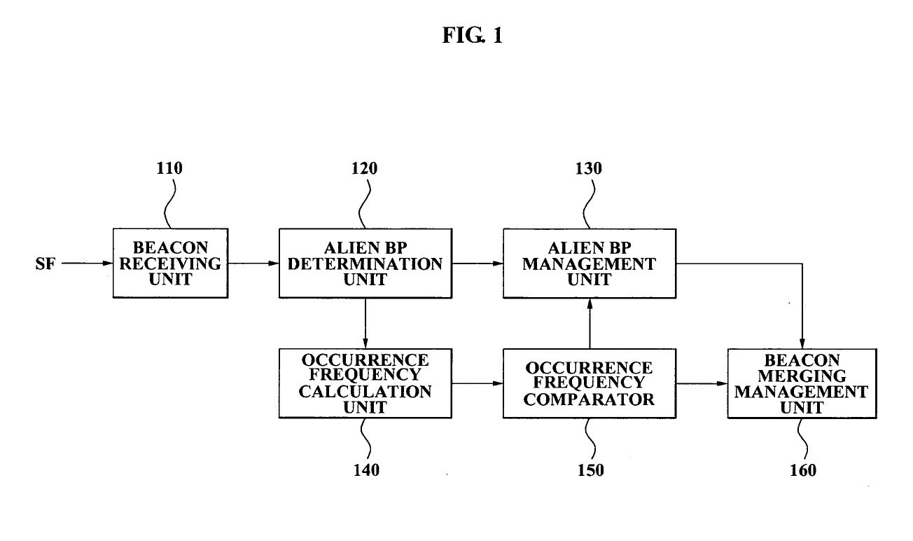

FIG. 1 is a block diagram illustrating an apparatus for merging beacons in a wireless local network according to an exemplary embodiment of the present invention.

Referring to FIG. 1 the apparatus for merging beacons in the wireless local network includes a beacon receiving unit 110, an alien beacon period (BP) determination unit 120, an alien BP management unit 130, an occurrence frequency calculation unit 140, an occurrence frequency comparator 150, and a beacon merging management unit 160.

The beacon receiving unit 110 receives a superframe (SF) from a beacon group of a corresponding device or an alien beacon group, and outputs the received superframe.

The alien BP determination unit 120 determines whether the received superframe is received from the alien beacon group.

In this instance, the alien BP determination unit 120 may determine whether the received superframe is identical to an alien superframe based on a BP Start Time (BPST) of the received superframe.

The alien BP management unit 130 protects a received alien BP, and releases the protection of the received alien BP.

In this instance, the alien BP management unit 130 releases the protection of the received alien BP when an occurrence frequency of the alien superframe received by the corresponding device is less; than a certain reference occurrence frequency. Specifically, when a continuous occurrence frequency of an alien superframe, which includes an alien BP identical to the received alien BP by the device, is less than the reference occurrence frequency and furthermore another alien superframe is received, the continuous occurrence frequency of the protected alien BP becomes less than the reference occurrence frequency. Therefore, the alien BP management unit 130 releases the protection of the alien BP, and protects the additionally received alien BP.

The occurrence frequency calculation unit 140 calculates the continuous occurrence frequency of the received alien BP by the corresponding device. Specifically, the occurrence frequency calculation unit 140 calculates the continuous occurrence frequency of the alien superframe which includes the same alien BP.

The occurrence frequency comparator 150 compares the calculated continuous occurrence frequency with the reference occurrence frequency. Specifically, the occurrence frequency comparator 150 compares the continuous occurrence frequency of the alien superframe, which is received by the corresponding device, with the reference occurrence frequency, and determines whether the alien superframe is temporarily received.

In this instance, the reference occurrence frequency may change according to a detection range of a device or an operational purpose of the device.

When the continuous occurrence frequency of the same alien BP is greater than or equal to the reference occurrence frequency as a result of the comparison by the occurrence frequency comparator 150, the beacon merging management unit 160 merges a beacon of a beacon group of the corresponding device with a beacon of an alien beacon group.

In this instance, the beacon merging management unit 160 may determine whether the beacon group of the corresponding device is identical to a reference beacon group, and generate BP switch information when the beacon group of the corresponding device is different from the reference beacon group.

Also, the beacon merging management unit 160 may merge the beacon of the beacon group of the corresponding device with the beacon of the alien beacon group, based on BP switch information received from the beacon group of the corresponding device or BP switch information received from the alien beacon group.

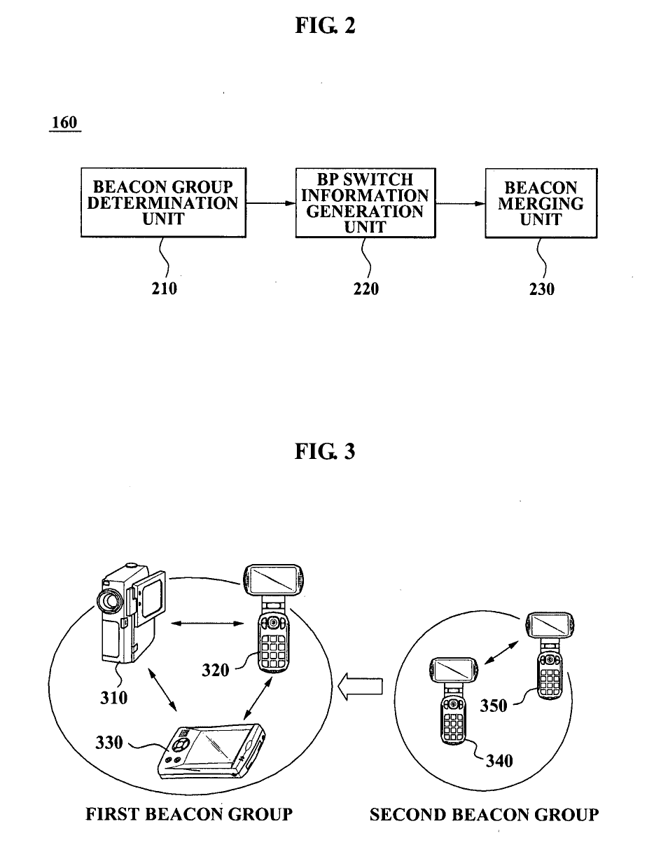

FIG. 2 is a block diagram illustrating the beacon merging management unit 160 of FIG. 1.

Referring to FIG. 2, the beacon merging management unit 160 includes a beacon group determination unit 210, a BP switch information generation unit 220, and a beacon merging unit 230.

The beacon group determination unit 210 determines whether a beacon group of a corresponding device is identical to a reference beacon group. Specifically, the beacon group determination unit 210 determines whether to expand a BP of the beacon group of the corresponding device, or whether to adjust a BPST of the beacon group of the corresponding device to a BPST of the alien beacon group.

When the beacon group of the corresponding device is different from the reference beacon group, the BP switch information generation unit 220 generates BP switch information. Specifically, the BP switch information generation unit 220 generates the BP switch information to adjust the BPST of the beacon group of the corresponding device to the BPST of the alien beacon group.

Here, devices of the beacon group may calculate a BPST offset based on the BP switch information, which is generated by, the BP switch information generation unit 220, and then adjust the BPST of the corresponding device to a BPST of the alien beacon group by using the calculated BPST offset.

The beacon merging unit 230 merges the beacon of the beacon group of the corresponding device with the beacon of the alien beacon group based on the generated BP switch information.

Here, when the beacon group of the corresponding beacon group is different from the reference beacon group, the beacon merging unit 230 may calculate the BPST offset based on the BP switch information, and then merge the beacon of the beacon group of the corresponding device with the beacon of the alien beacon group by using the calculated BPST offset.

Conversely, when the beacon group of the corresponding device is identical to the reference beacon group, the beacon merging unit may expand a BP based on the BP switch information, which is received from a device of the alien beacon group, and then merge the beacon of the beacon group of the corresponding device with the beacon of the alien beacon group.

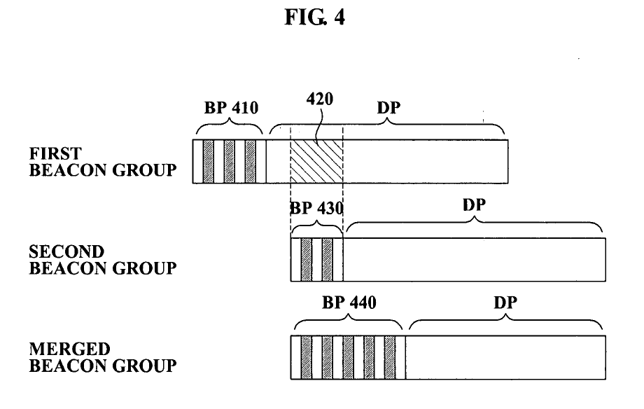

Operations of an apparatus for merging beacons in the wireless local network according to an exemplary embodiment of the present invention, as shown in FIGS. 1 and 2, will be described further with reference to FIGS. 3 and 4.

FIG. 3 is a diagram illustrating an example of two beacon groups to explain an apparatus for merging beacons in a wireless local network according to an exemplary embodiment of the present invention.

FIG. 4 is a diagram illustrating an example of before and after merging two beacon groups according to an exemplary embodiment of the present invention.

Referring to FIGS. 3 and 4, a first beacon group includes a first device 310, a second device 320, and a third device 330. A second beacon group includes a fourth device 340 and a fifth device 350.

Hereinafter, it is assumed that the second beacon group moves to the first beacon group, the second device 320 receives a superframe from the second beacon group, and the second beacon group is a reference beacon group.

When the second device 320 receives the superframe from the second beacon group while the fourth device 340 and the fifth device 350 of the second bean group are moving, an alien BP determination unit of the second device 320 determines whether a BP received by the second device 320 is identical to an alien BP based on the received superframe. For example, as shown in FIG. 4, the alien BP determination unit determines the BP 430 received by the second device 320 is identical to the alien BP since a BPST of the received superframe from the second beacon group is positioned in a data period (DP) area 420.

The alien BP management unit protects the BP of the second beacon group which is detected in the DP area 420.

Also, an occurrence frequency calculation unit calculates an occurrence frequency of the alien superframe received from the second beacon group. For example, the occurrence frequency calculation unit calculates a number of times that the alien superframe is continuously received, using a counter and the like.

Also, when a third beacon group is provided in addition to the first beacon group and the second beacon group, and in this instance, another alien superframe is received from the alien beacon group, the occurrence frequency calculation unit determines whether the received alien superframe is transmitted from the same alien beacon group.

Specifically, when a device of the first beacon group receives an alien superframe, it is determined from which beacon group between the second beacon group and the third beacon group the received alien superframe is transmitted. Only when the received alien superframe is transmitted from a beacon group identical to the beacon group of a previously received alien superframe, the occurrence frequency calculation unit calculates the occurrence frequency of the alien superframe or an alien BP using a counter and the like.

Also, when the received alien superframe is transmitted from another beacon group different from the beacon group of the previously received alien superframe, the occurrence frequency calculation unit resets a previously calculated occurrence frequency of the alien superframe, and calculates the occurrence frequency with respect to the additionally received alien superframe of the different beacon group.

Here, when the received alien superframe is transmitted from the different beacon group from the beacon group of the previously received alien superframe, the alien BP management unit may release the protection of the received alien BP, and protect an additionally received alien BP.

An occurrence frequency comparator of the second device 320 compares a continuous occurrence frequency of the alien BP of the second beacon group, which is calculated by the occurrence frequency calculation unit, with the reference occurrence frequency. When the occurrence frequency of the alien BP reaches the reference occurrence frequency, this event is reported to a beacon merging unit of the second device 320.

The beacon merging unit of the second device 320 generates BP switch information including BPST offset information, since the first beacon group is different from the reference beacon group. Also, the beacon merging unit merges a beacon of the first beacon group with a beacon of the second group based on the generated switch information. Specifically, the first device 310, and the third device 330 of the first beacon group and the fourth device 340 and the fifth device 350 of the second beacon group receive a superframe, which includes the BP switch information generated by the second device 320, and merges the beacon of the first beacon group with the beacon of the second beacon group based on the BP switch information of the received superframe.

In this instance, the first device 310 and the third device 330 of the first beacon group receive the superframe from the second device 320, and also receive BP switch information which is included in the received superframe. Also, the first device 310 and the third device 330 calculate a BPST offset for merging BP, and adjust a BPST of the first beacon group to be identical to the BPST of the second beacon group by using the calculated BPST offset.

Also, the fourth device 340 and the fifth device 350 of the second beacon group receive the superframe from the second device 320 of the first beacon group, and expand the BP for merging the BP based on the received superframe.

Specifically, as shown in FIG. 4, a beacon slot allocated to a BP area 410 of the first beacon group is realigned in a BP area 440 of the merged beacon group i.e., an expanded BP area of the second beacon group.

As described above, the beacon merging apparatus according to the present exemplary embodiment does not perform a merging every time an alien BP is received, but performs the merging only when an occurrence frequency of the alien BP is greater than or equal to a certain reference occurrence frequency. Accordingly, it is possible to prevent an unnecessary merging of beacons, which may be caused by a temporarily received alien BP.

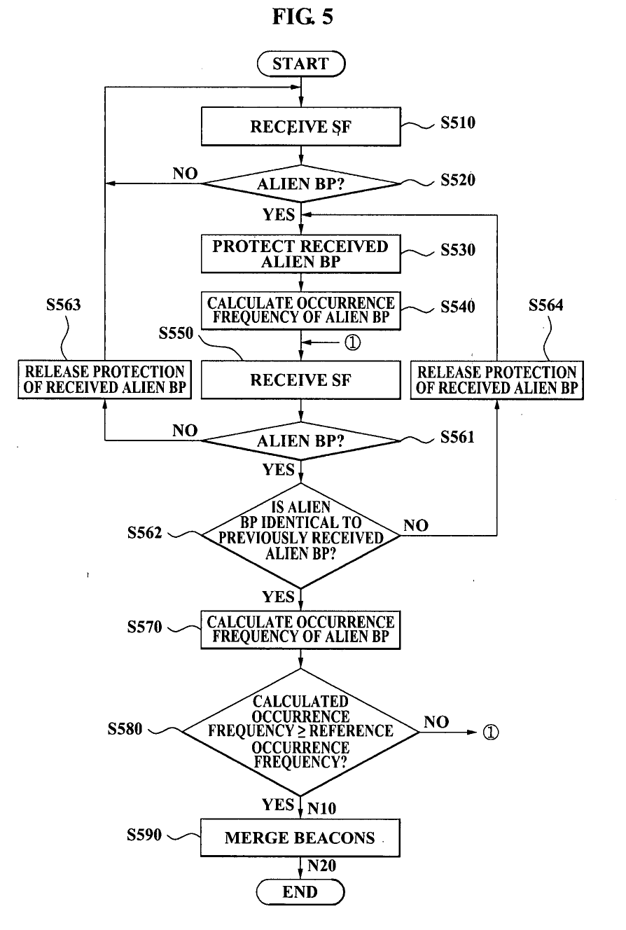

FIG. 5 is a flowchart illustrating a method of merging beacons in a wireless local network according to an exemplary embodiment of the present invention.

Referring to FIG. 5, in operation S510, a corresponding device of a beacon group receives a superframe which is transmitted from the beacon group of the corresponding device or from an alien beacon group.

In operation S520, the device determines whether the received superframe is identical to an alien superframe, i.e. whether the received superframe includes an alien BP.

In this instance, the determination may be made based on a BPST.

When the received superframe is identical to the alien superframe, the corresponding device protects the received alien BP in operation S530, and calculates an occurrence frequency of the alien BP using a counter and the like in operation S540.

In this instance, the occurrence frequency of the alien BP may be calculated and then the calculated occurrence frequency may be compared with a reference occurrence frequency.

In operation S550, the device receives an additional superframe. In operation S561, the device again determines whether the received superframe includes an alien BP.

In operation S562, when the received superframe is determined to include the alien BP in operation S561, the device determines whether the alien BP is identical to a previously received alien BP. Specifically, the device determines whether the identical alien BP is continuously received.

In operation S563, when the received superframe is determined to exclude the alien BP in operation S561, the device releases the protection of the alien BP.

Also, when the received alien BP is determined to be different from the previously received alien BP in operation S562, the device releases the protection of the received alien BP in operation S564, and protects the additionally received alien BP by again performing operation S530.

In this instance, when the protection of the received alien BP is released, the calculated occurrence frequency of the alien BP is reset.

In operation S570, when the received alien BP is determined to be identical to the previously received alien BP in operation S562, the device calculates the occurrence frequency of the alien BP. Specifically, “1” is added to the previously calculated occurrence frequency of the alien BP.

In operation S580, the device determines whether the calculated occurrence frequency of the alien BP is greater than or equal to a certain reference occurrence frequency.

In this instance, the reference occurrence frequency may change according to a detection range of the device or an operational purpose of the device.

When the calculated occurrence frequency of the alien BP is determined to be less than the reference occurrence frequency in operation S580, the device returns to and restarts from operation S550.

Conversely, when the calculated occurrence frequency of the alien BP is determined to be greater than or equal to the certain reference occurrence frequency in operation S580, the device merges a beacon of the beacon group of the corresponding device with a beacon of the alien beacon group in operation S590.

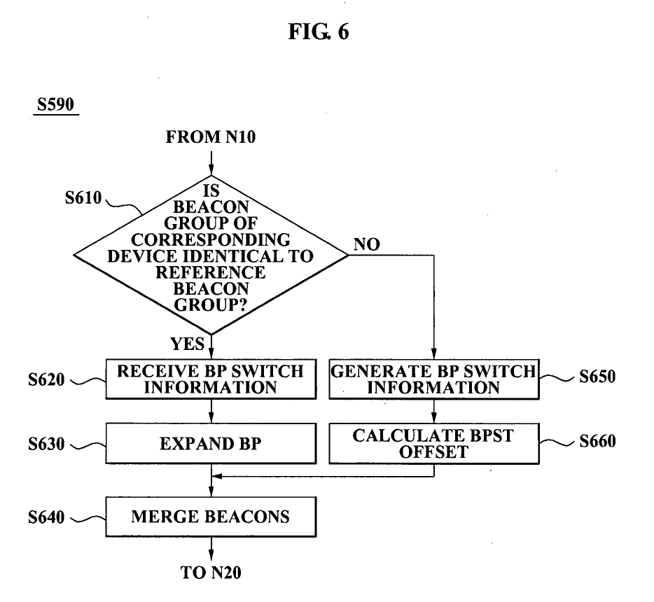

FIG. 6 is a flowchart illustrating operation S590 of FIG. 5.

In operation S610, in merging beacons, the device determines whether the beacon group of the corresponding device is identical to the reference beacon group.

When the beacon group of the corresponding device is determined to be identical to the reference beacon group in operation S610, the device receives BP switch information from the alien beacon group in operation S620, expands a BP based on the BP switch information in operation S630, and merges the beacon of the beacon group of the corresponding device with the beacon of the alien beacon group in operation S640.

Conversely, when the beacon group of the corresponding device is determined to be different from the reference beacon group in operation S610, the device generates BP switch information in operation S650, calculates a BPST offset based on the generated BP switch information in operation S660, and then merges the beacon of the beacon group of the corresponding device with the beacon of the alien beacon group in operation S640.

In this instance, in the case of a device whose beacon group is different from the reference beacon group and which does not generate BP switch information, the device may receive a superframe from another device which generates the BP switch information, calculates a BPST, offset based on the BP switch information which is included in the received superframe, and then merge a beacon of a beacon group of the corresponding device with the beacon of the alien beacon group by using the calculated BPST offset.

The beacon merging method of the wireless local network according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, an apparatus and method of merging beacons in a wireless local network may prevent an unnecessary merging of beacons, which may be caused by a temporarily received alien beacon.

Also, according to the present invention, it is possible to remove an unnecessary merging of beacons and thereby reduce an unnecessary resource consumption and power consumption.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of merging beacons in a wireless local network, the method comprising:
calculating a continuous occurrence frequency of a received alien beacon period (BP);
comparing the calculated occurrence frequency with a certain reference occurrence frequency; and
merging a beacon group of a corresponding device with an alien beacon group when the calculated occurrence frequency is greater than or equal to the reference occurrence frequency.

2. The method of claim 1, further comprising:
protecting the received alien BP; and
releasing the protection of the received alien BP when the calculated occurrence frequency is less than the reference occurrence frequency.

3. The method of claim 1, wherein the calculating determines whether the received alien BP is identical to a previously received alien BP, and calculates the continuous occurrence frequency of the identical alien BP when the received alien BP is identical to the previously received alien BP.

4. The method of claim 1, wherein the reference occurrence frequency is applied by a different superframe time according to a detection range of a device or an operational purpose of the device.

5. A computer-readable recording medium storing a program for implementing a method of merging beacons in a wireless local network, the method comprising:
calculating a continuous occurrence frequency of a received alien BP;
comparing the calculated occurrence frequency with a certain reference occurrence frequency; and
merging a beacon group of a corresponding device, with an alien beacon group when the calculated occurrence frequency is greater than or equal to the reference occurrence frequency.

6. An apparatus for merging beacons in a wireless local network, the apparatus comprising:
an occurrence frequency calculator which calculates a continuous occurrence frequency of a received alien BP;
an occurrence frequency comparator which compares the calculated occurrence frequency with a certain reference occurrence frequency; and
a beacon merging management unit which merges a beacon group of a corresponding device with an alien beacon group when the calculated occurrence frequency is greater than or equal to the reference occurrence frequency.

7. The apparatus of claim 6, further comprising:
an alien BP management unit which protects the received alien BP, and releases the protection of the received alien BP when the calculated occurrence frequency is less than the reference occurrence frequency.

8. The apparatus of claim 6, further comprising:
an alien BP determination unit which determines whether the alien BP is received based on a received superframe.

9. The apparatus of claim 8, wherein the occurrence frequency calculator determines whether the received alien BP is identical to a previously received alien BP, and calculates the continuous occurrence frequency of the identical alien BP when the received alien BP is identical to, the previously received alien BP.

10. The apparatus of claim 6, wherein the beacon merging management unit comprises:
a beacon group determination unit which determines whether the beacon group of the corresponding device is identical to a reference beacon group;
a BP switch information generation unit which generates BP switch information when the beacon group of the corresponding device is different from the reference beacon group; and
a beacon merging unit which merges the beacon group of the corresponding device with the alien beacon group based on the BP switch information.

11. The apparatus of claim 10, wherein the beacon merging unit calculates a BP Start Time (BPST) offset based on the BP switch information and then merges the beacon group of the corresponding device with the alien beacon group by using the calculated BPST offset, when the beacon group of the corresponding group is different from the reference beacon group.

12. The apparatus of claim 10, wherein the beacon merging unit expands a BP based on the BP switch information, which is received from a device of the alien beacon group, and then merges the beacon group of the corresponding device with the alien beacon group when the beacon group of the corresponding device is identical to the reference beacon group.

13. The apparatus of claim 6, wherein the reference occurrence frequency is applied by a different superframe time according to a detection range of a device or an operational purpose of the device.
